(19) United States
(12) Patent Application Publication
(10) Pub. No.: US 2007/0043955 A1
(43) Pub. Date: Feb. 22, 2007

(54) Logon user interface feedback

(75) Inventors: Anastasia C. Doerr, Redmond, WA (US); James H. Hong, Redmond, WA (US); Jerry K. Koh, Redmond, WA (US); Latika Kirtane, Redmond, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/208,335

(22) Filed: Aug. 18, 2005

(51) Int. Cl. H04L 9/32; H04K 1/00; G06K 9/00; H04L 9/00; G06F 17/30; G06F 7/04; G06F 15/16; G06F 7/58; G06K 19/00

(52) U.S. Cl. 713/186; 726/2; 726/4

(57) ABSTRACT

Methods and systems to provide a user tile to a user of a computer device relating to a logon process are provided. In one aspect, the user tile is configured to supply feedback to the user regarding the status of the logon process through a graphical representation. In at least one embodiment, the user tile may be individualized to a user or a class of users. Further aspects of the invention relate to methods and systems to select and display a user tile comprising graphical representations to provide feedback to a user on the method of logging on the computer device. In one embodiment, a plurality of user tiles are used to provide feedback to the user. In one such embodiment, one tile may be used to provide feedback on how to log on to the computer, while one or more additional tiles may be used to provide feedback on the status of the logon procedures for different applications.

### BACKGROUND

Most computer devices require a user to log on to the device before being able to execute applications or functions of the operating system. Generally, the user provides an input to the computer device identifying the user and, in most cases, must provide a user input to authenticate the user, usually in the form of a textual password or pass code.

This is most readily seen in the desktop computer platforms running operating systems, such as for example, Microsoft® Windows®. Upon initiating a boot sequence, the user is provided a logon screen. The operating system may then allow the user to select which user is attempting to log on to the computer and enter a password in the form of text to gain entry to the applications on the computer. Indeed, even if a password is not required, the operating system may require the user to log on as a “Guest”, in which only a portion of the available applications on the computer device are accessible.

Increasingly, users are storing sensitive information and/or applications on computer devices. One consequence of this trend is the greater importance of securing data housed on the device; therefore more secure methods of authenticating users have entered the marketplace, such as biometric readers, such as, iris scanners and fingerprint readers. However, utilizing these and other newer methods of authentication may confuse the user, reduce the enjoyment of the computing experience, and/or are absent from providing the user with adequate feedback on the process of logon procedures.

### SUMMARY

Aspects of the invention relate to methods and systems to provide a user tile to a user of a computer device to provide feedback to the user regarding the status of the logon process through at least one graphical representation. In at least one embodiment, the user tile may be individualized to a user or a class of users. Further aspects of the invention relate to methods and systems to select and display a user tile comprising graphical representations to provide feedback to a user on the method available to log on the computer device. In one embodiment, a plurality of user tiles are used to provide feedback to the user. In one such embodiment, one tile may be used to provide feedback on how to log on to the computer, while one or more additional tiles may be used to provide feedback on the status of the logon procedures for different applications.

These and other advantages will become apparent from the following detailed description when taken in conjunction with the drawings, A more complete understanding of the present invention and the advantages thereof may be acquired by referring to the following description in consideration of the accompanying drawings, in which like reference numbers indicate like features, and wherein:

### BRIEF DESCRIPTION OF THE DRAWINGS

FIG. 1 illustrates an exemplary computer system in which embodiments of the invention may be implemented.

FIG. 2 illustrates a functional block diagram of one method of providing feedback to a user through a user tile according to one embodiment of the present invention.

FIGS. 3a-3c show illustrative user tiles that may be used in according to various embodiments of the present invention.

### DETAILED DESCRIPTION

Exemplary Operating Environment

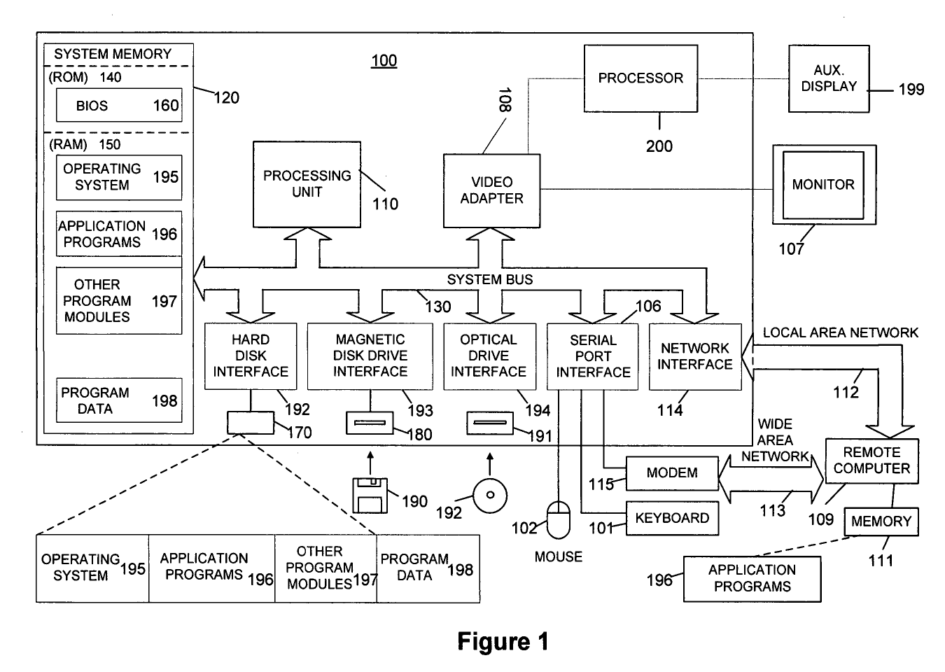

FIG. 1 is a functional block diagram of an example of a conventional general-purpose digital computing environment that can be used in connection with the methods and systems of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). The illustrated computer 100 includes an optional PCMCIA interface 103 that may connect at least one embodiment of an input device according to the present invention to the computer 100. Further still, these devices may be coupled directly to the system bus 130 via an appropriate interface (not shown). A monitor 107 or other type of display device is also connected to the system bus 130 via an interface, such as a video adapter 108. An auxiliary display device 199 may also be in communication with computer 100. The auxiliary device may be integrated within the computer (as shown), detachable, or external. The auxiliary display device 199 may optionally be in communication with an auxiliary processor 200, which may be integrated within the auxiliary display or housed within the computer 100. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used. The existence of any of various well-known protocols such as TCP/IP, Ethernet, FTP, HTTP, Bluetooth, IEEE 802.11x and the like is presumed, and the system can be operated in a client-server configuration to permit a user to retrieve web pages from a web-based server. Any of various conventional web browsers can be used to display and manipulate data on web pages.

Description ofillustrative Embodiments

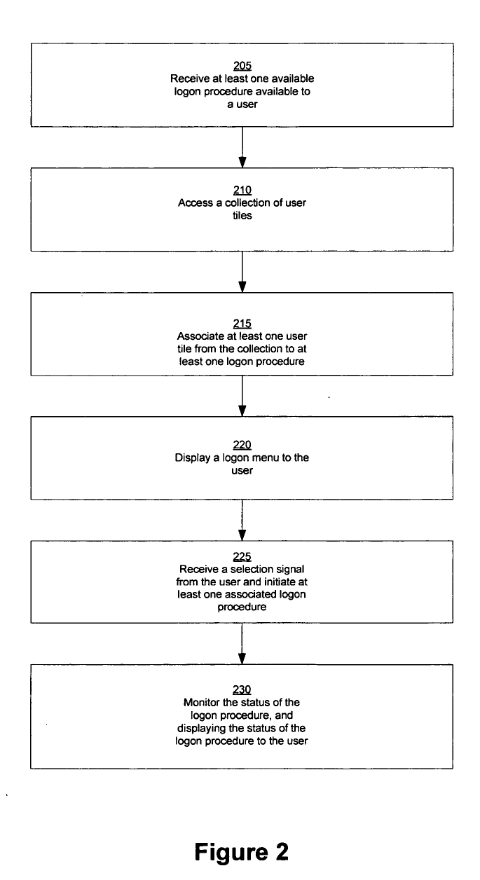

FIG. 2 illustrates a functional block diagram of one method of providing feedback to a user through a user tile according to one embodiment of the present invention. In step 205, a computer device, such as computer 100 having software loaded onto a memory, such as memory 120, receives at least one logon procedure that is available to the user. For example, at any given time, a logon procedure may be available from the operating system 195 or application programs 196. Yet in another situation, multiple application programs may be available for simultaneous logon attempts by a user.

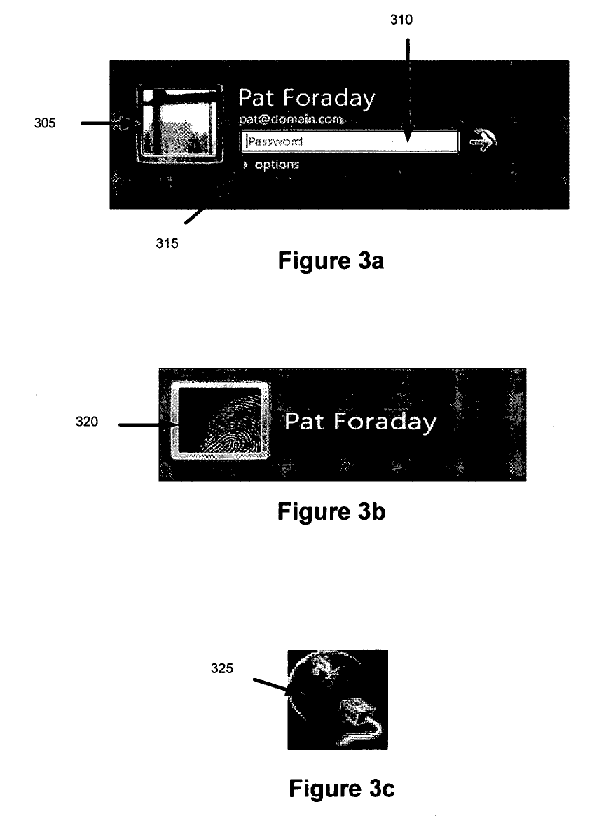

In step 210, a collection of user tiles is accessed. The collection may be stored in any readable computer media, for example, on hard disk 170 or magnetic disk 180. Yet in other embodiments, the collection of user tiles may be stored remotely and accessed through network interface 114, for example. As one skilled in the art will realize, in one embodiment, a collection of user tiles may be stored locally and may be updated with tiles stored remotely. In one such embodiment, the user of the computer, such as computer 100, may customize the tiles, class of tiles, and/or number of tiles remotely accessed. As readily seen with user tiles 305, 320, 325, shown in FIGS. 3a-3c respectively, the tiles of the present invention comprise at least one graphical representation. In this regard, the user tile may resemble an icon, such as those utilized on the desktop of operating systems, such as Microsoft® Windows®; however, other aspects of the user tiles and the use of the tiles according to various aspects of the invention, separate the user tiles from the icons described above. Moreover, as one skilled in the art will appreciate, a single user tile may comprise a plurality of graphical representations.

In step 215, at least one user tile from the collection of user tiles is associated with at least one of the logon procedures available in step 205. The associated user tiles are then displayed to the user (step 220), for example, through monitor 107 or auxiliary display device 199. FIG. 3a illustrates one embodiment of step 220 in the form of a logon screen. As seen in the figure, a user tile 305 is displayed on a display device to the user. The user tile 305 may be specific to a user or class of users. In other embodiments, at least one graphical representation in the user tile is specific to a user or class of users. For example, in the illustrated embodiment, the tile is specific to the user “Pat Foraday”. Yet in other embodiments, the tile may be specific to a plurality of users, for example, those users with Administrative Rights on the computer. The user tile may further be associated with an input field, such as text box 310. In one embodiment, the user may be required to enter a password in text box 310 before being permitted to log onto the application or applications. In yet other embodiments, other input fields may be present in the place of or in addition to text box 210. One such input field, may be options selection field 315 that may be configured to allow the user to configure the user tile and/or the logon procedures, among other configurable features known to those skilled in the art.

In one embodiment, user tile(s) displayed in step 220 comprise at least one graphical representation to provide feedback of at least one aspect of the logon process to the user or class of users. The graphical representation may overlay, be adjacent to, or switch between other graphical representations within the user tile. As one skilled in the art will appreciate, one or more graphical representations of the user tile may be animated and/or accompanied by sound or other outputs designed to be received by the user. FIG. 3b shows one illustrative example of a user tile that comprises at least one graphical representation to provide feedback of at least one aspect of the logon process to the user or class of users. As seen in the figure, user tile 320 comprises a graphical representation of a fingerprint indicating the user must provide a biometric input, in the form of a fingerprint, to initiate the associated logon procedure. As one skilled in the art will realize, other graphical representations could be used to indicate a biometric input is required before initiating one or more logon procedures, such as for example, a picture of an eye or portion thereof to indicate an iris scan is required or an outline of a face or the like to indicate a facial scan is required. It is to be understood that the present invention is not limited to graphical representations to provide feedback that a biometric input is needed. Indeed, any graphical representation that conveys feedback to the user of the type of input required to initiate or otherwise facilitate a logon procedure is within the scope of the invention. For example, FIG. 3c illustrates user tile 325 which may be used to provide feedback to a user that a network connection is needed to initiate or otherwise facilitate the associated logon procedure.

Yet in other embodiments, graphical representations may be used to convey the type of application or applications accessible with the associated logon procedures. Such graphical representations may be in addition to graphical representations that are specific to the individual user or class of users and/or provide feedback to the user regarding the logon procedure. As one skilled in the art will understand, multiple user tiles may be associated with a single logon procedure to provide any or all of the above information to the user. For example, user tile 305 may be used in conjunction with user tiles 320 and 325, wherein user tile 305 specifically identifies the user (i.e., Pat Foraday), user tile 320 indicates a fingerprint is required from “Pat Foraday” to initiate the logon sequence, and user tile 325 may indicate that 1) a network connection is needed to initiate the logon sequence and/or 2) the associated procedure is a network connection, depending on the configuration of the user tiles. Likewise, the graphical representations in user tiles 305, 320, and 325 may be housed within a single user tile, for example, as described above.

In step 225, the computer receives an input from a user selection device selecting at least one of the available logon procedures or group of procedures, and in response to the selection, initiating the procedure(s). As one skilled in the art readily knows, there are a large number of possible mechanisms to provide an input to a computer device to select the procedure(s), including but not limited to: keyboards, mice, trackballs, light pens, and heat or pressure sensitive devices.

In yet another embodiment, a plurality of user tiles are displayed to the user, each user tile being utilized to indicate the type of input required to initiate differing logon processes, wherein each one grants the user different levels of access. For example, one user tile may comprise a graphical representation of a fingerprint wherein another user tile comprises a graphical input of an iris scan, wherein an input in the form of a fingerprint will initiate a subset of processes within the associated logon procedure and providing an input in the form of an iris scan will initiate all of the processes of a logon procedure.

In still yet another embodiment, at least one user tile is displayed on a display device to a user, wherein the tile(s) comprise information that must be viewed and interpreted by a user before a logon process may be initiated. In one such embodiment, text (or graphical representations of text) may be positioned within the user tile and the user may be required to first view and recognize the text before providing an input through a user interface selection device to indicate the user has correctly viewed and interpreted the text and/or graphical representation within the user tile. As one skilled in the art will appreciate, there are numerous methods that may be employed that may require a user to first view and recognize a characteristic of a user tile before entering an input to demonstrate recognition of the particular characteristic. For example, the user tile may show a color in a portion of the user tile, such as the border region, thereby requiring the user to input the “name” or other defining characteristic of the color into a input field before logon procedures may be implemented.

Step 230 may be implemented to monitor the status of the logon procedure, and providing an updated user tile to provide graphical feedback to the user regarding the status of the logon procedure. As one skilled in the art will realize, “updating” a user tile may comprise processes that replace the user tile, add or remove graphical representations from the tile, augment the size and/or shape or the tile, and/or adding other aspects to the tile to provide feedback to the user, for example, output mechanisms such as sound files or animation. For example, in one embodiment, user Pat Foraday may individualize a graphical representation to appear on user tile 305 during a predetermined logon screen that requires a fingerprint scan to initiate the logon process. The graphical representation may be the image that appears in user tile 305 as shown in FIG. 3a. Upon receiving a proportion of the user's fingerprint scan, the user tile may be updated to reflect the portion of the fingerprint scanned. For example, the image shown in user tile 320 may be shown within the user tile. Yet in other embodiments, the relevant portion of the image reflecting the portion of the fingerprint scanned is highlighted or otherwise illuminated, such as in a contrasting color to provide non-textual graphical feedback to the user regarding the status of the logon process. In embodiments requiring handwriting authentication, the user tile may be updated to reflect the handwriting sample being inputted or the portion of the handwriting sample being authenticated. Indeed, any graphical representation to provide feedback regarding status of the logon processes is within the scope of the invention. Additional graphical representations may be included within the same tile or other user tiles to indicate the status of other logon procedures being executed. For example, as user tile is being updated to reflect the proportion of fingerprint scanned, the user tile may also provide a non-textual graphical representation of the status of a connection to a network.

The present invention has been described in terms of exemplary embodiments. Numerous other embodiments, modifications and variations within the scope and spirit of the appended claims will occur to persons of ordinary skill in the art from a review of this disclosure. For example, one skilled in the art will realize that additional or less steps may be implemented to display and associate the user tiles of the present invention. Moreover, while the exemplary embodiments illustrate the use of user tiles in a PC environment, the invention, however, may be configured for personal gaming systems, such as Sony® Playstation® or Microsoft® Xbox®, handheld systems such as a Palm® or Treo®, among others, for example, cellular-based applications. In still yet further embodiments, the invention is configured for web-based applications that may be incorporated within or independent of cellular-based applications.

We claim:

1. In a computer system having a graphical user interface including a display and a user interface selection device, a method of providing feedback through a user tile comprising the steps of:
(a) receiving at least one available logon procedure available to a user of the computer system;
(b) accessing a collection of user tiles, wherein each user tile comprises at least one graphical representation;
(c) associating at least one user tile from the collection to the at least one logon procedure available to the user;
(d) displaying on the display a logon menu comprising the at least one user tile associated with at least one logon procedure;
(e) receiving a selection signal indicative of the user interface selection device selecting at least one logon procedure, and, in response to the selection signal, initiating the at least one logon procedure;
(f) receiving the status of the initiated logon procedure; and
(g) displaying on the display at least one updated user tile, wherein the updated user tile is configured to provide graphical feedback regarding the status of the at least one logon procedure to the user of the computer device during the logon procedure.

2. The method of claim 1, wherein the at least one user tile further comprises a graphical representation to provide the user feedback on how to initiate the associated logon procedure.

3. The method of claim 2, wherein the at least one user tile comprises graphical representation to indicate a biometric input is required to initiate the associated logon procedure.

4. The method of claim 3, wherein the graphical representation is selected from the group consisting of: fingerprints, eyes, facial features, or combinations thereof.

5. The method of claim 2, further comprising the step of:
(h) allowing a user to customize the at least one user tile that is displayed on the display.

6. The method of claim 1, wherein the updated user tiles are animated to indicate the status of the logon procedure.

7. The method of claim 6, wherein a biometric input is required to initiate the logon procedure, a graphical representation selected from the group consisting of: fingerprints, eyes, facial features, or combinations thereof is displayed to the user; wherein the amount of the graphical representation displayed to the user is proportional to the amount of the biometric input received.

8. The method of claim 1, further comprising the step of:
(h) allowing a user to customize the at least one user tile that is displayed on the display.

9. The method of claim 1, wherein the at least one user tile further comprises a graphical representation to identify at least on user that may initiate the associated logon procedure.

10. A method of providing feedback in a user tile to a user of a computer device, the method comprising the steps of:
(a) detecting a logon procedure available to the user; and
(b) based upon the logon procedure detected, determining at least one user tile to display to a user, wherein the at least one user tile is configured to provide feedback of at least one aspect of the logon procedure to the user through at least one graphical representation.

11. The method of claim 10, further comprising the steps of:
(c) determining the status of a logon process; and
(d) based upon the status of the logon process, augmenting the at least one user tile to a user, wherein the user tile comprises a graphical representation of the status of the logon process.

12. The method of claim 11, wherein step (d) includes replacing at least one user tile with a new user tile.

13. The method of claim 11, wherein at least two user tiles are displayed to the user, user tiles being further configured to provide feedback to the user on how to initiate at least one logon process.

14. The method of claim 13, further comprising the steps of:
(e) allowing a user to provide an input to the computer device to select at least one of the user tiles, wherein the input required to select each of the user tiles differs; and
(f) based upon the user input, initiating a logon process, wherein the logon process is dependant on the input received.

15. The method of claim 14, further comprising the step of:
(g) allowing a user to customize the at least one user tile that is displayed.

16. The method of claim 10, wherein the at least one user tile further comprises a graphical representation to identify at least on user that may initiate the associated logon procedure.

17. A computer device having a display device and a computer-readable medium, wherein the computer readable medium has computer-executable instructions for performing steps comprising:
(a) initiating an operating system;
(b) displaying on the display a logon screen to a user, wherein the logon screen comprises at least one user tile, the at least one user tile comprising non-textual graphical representations;
(c) receiving at least one input from the user, the input being an attempt by the user to logon to the computer device;
(d) monitoring the logon attempt;
(e) based upon the logon status, updating the at least one user tile displayed to the user, wherein the at least one updated user tile is configured to provide feedback of at least one aspect of the logon status to the user through a non-textual graphical representation.

18. The method of claim 17, wherein the at least one user tile further comprises a graphical representation to provide the user feedback on how to initiate the logon to the computer device.

19. The method of claim 18, wherein the at least one user tile comprises graphical representation to indicate a biometric input is required to initiate the logon to the computer device.

20. The method of claim 19, wherein the graphical representation is selected from the group consisting of: fingerprints, eyes, facial features, or combinations thereof.
